(19) United States
(12) Patent Application Publication
(10) Pub. No.: US 2025/0015261 A1
(43) Pub. Date: Jan. 9, 2025

(54) LEAD ACID BATTERY WITH POSITIVE ELECTRODE COMPRISED OF GRID AND LEAD-BASED ACTIVE MASS, NEGATIVE ELECTRODE COMPRISED OF BASE AND ACTIVE METAL, AND ELECTROLYTE

(71) Applicant: B.C. ENERGY STORAGE LTD., Hadera (IL)

(72) Inventor: Pavel Bykov, Hadera (IL)

(21) Appl. No.: 18/712,377

(22) PCT Filed: Nov. 22, 2022
(86) PCT No.: PCT/IL2022/051244

§ 371 Date: May 22, 2024

(30) Foreign Application Priority Data
Nov. 24, 2021 (IL) 288354

(51) Int. Cl. H01M 4/14; H01M 4/02; H01M 4/36; H01M 4/38; H01M 10/08

(52) U.S. Cl. CPC H01M 4/14; H01M 4/366; H01M 4/38; H01M 10/08; H01M 2004/021; H01M 2004/027; H01M 2004/028; H01M 2300/0011

(57) ABSTRACT

A lead acid battery includes a positive electrode comprised of a grid filled with a lead-based active mass. A negative electrode is comprised of a base material. A spacer maintains a distance between the positive and negative electrodes. The battery further includes an active metal and an electrolyte solution. In a process of discharge, the active metal is dissolved in the electrolyte solution, and in a process of charge, the active metal is deposited onto the base material.

### RELATED APPLICATIONS

This Application claims priority to Israeli Patent Application No. 288,354, entitled “Lead Acid Battery with Positive Electrode Comprised of Grid and Lead-based Active Mass, Negative Electrode Comprised of Base and Active Metal, and Electrolyte,” filed Nov. 24, 2021, the contents of which are incorporated by reference as if fully set forth herein.

### FIELD OF THE INVENTION

The present disclosure, in some embodiments, concerns a lead acid battery, and more specifically, but not exclusively, to a lead acid battery including a positive electrode comprised of a grid containing a lead-based active mass, a negative electrode comprised of a base material, and an active metal that is deposited onto the base during a charging process and is dissolved into the electrolyte during a discharging process.

### BACKGROUND OF THE INVENTION

Lead acid batteries have been in use for over 150 years, and are widely used for automobile batteries and backup power supplies.

A standard lead acid battery has a positive electrode consisting of a lead-based grid and of an active mass of lead dioxide (PbO₂), a negative electrode consisting of a lead-based grid and of an active mass of lead (Pb), and an electrolyte of aqueous sulfuric acid (H₂SO₄). In the discharging process, the active masses of the positive and negative electrodes are both converted to lead sulfate (PbSO₄), and the sulfuric acid becomes diluted in the aqueous solution. In the charging process, the lead sulfate is converted back to lead dioxide and lead, and the sulfuric acid becomes concentrated in the aqueous solution.

Standard lead acid batteries currently suffer from numerous challenges.

First, standard lead acid batteries are sensitive to deep discharge. One of the main reasons for this sensitivity is that the volume of the active material of the negative electrode significantly exceeds the volume of the active material of the positive electrode. This leads to a transition from the reaction forming lead sulfate to reactions with the formation of lead hydroxide (Pb(OH)₂), which, in turn, causes swelling of the active material of the positive electrode. With subsequent charges, the active material peels off of the grid of the electrode, and, over time, the active material falls out of the grid. Accordingly, the volume of the active material of the positive electrode decreases, and the deep discharge occurs earlier than desired.

A second challenge of standard lead acid batteries is low battery life due to destruction of the positive electrode during the charging process. During the charging process, the main summarized reaction on the electrodes (both positive and negative) is:

$$2 {PbSO}_{4} + 2 {H}_{2} O = Pb + {PbO}_{2} + 2 {H}_{2} {SO}_{4} \qquad ( Reaction 1 )$$

However, at the end of the charge, the release of hydrogen and oxygen leads to a secondary reaction at the positive electrode of Pb+O₂=PbO₂. The positive electrode thus gradually begins to get destroyed. A thin layer of PbO₂ forms on the grid of the positive electrode, preventing further destruction of the grid in this charging cycle, but, in the subsequent charging cycle, another thin layer of the grid will be destroyed.

A third challenge of standard lead acid batteries is low battery life due to self-discharge of the battery at the positive electrode. When the battery is discharging, the main summarized reaction on the electrodes (both positive and negative) is:

$$Pb + {PbO}_{2} + 2 {H}_{2} {SO}_{4} = 2 {PbSO}_{4} + 2 {H}_{2} O \qquad ( Reaction 2 )$$

Structurally, the positive electrode after charging is a lead grid in close contact with lead dioxide. Immediately after removing the charging voltage, the reaction described in Reaction 2 starts at the contact points between the lead and lead dioxide on the positive electrode. As a result, the grid on the positive electrode is locally destroyed, and the internal resistance of the battery increases. As the thickness of the lead sulfate layer increases, the reaction speed of this self-discharge slows down, but it does not completely stop.

As a result of the second and third challenges, a typical lead-acid battery lasts only 400-600 charge-discharge cycles. After this number of cycles, the positive electrode grid is completely destroyed, and the battery completely malfunctions.

A fourth challenge of standard lead-acid batteries is the large battery weight. Lead is used as the active metal in both the positive and negative electrodes. Lead is an exceedingly heavy metal, with a density of 11.3 g/cm³ at standard temperature and pressure. There are 3.8-4.0 grams of lead per 1 watt-hour capacity. In addition, the grids of the electrodes are also made of lead. These grids are used to hold the active material and conduct electricity.

A fifth challenge of standard lead acid batteries involves the gradual lowering of the electrolyte level. The lowering of the electrolyte level occurs for two reasons: the decomposition of water into hydrogen and oxygen when the battery is overcharged, followed by volatilization, as well as natural evaporation of water from the electrolyte. As the electrolyte level drops, the working surface of the electrodes decreases, which leads to a decrease of electricity capacity, and the speed of evaporation of water from the electrolyte increases further.

Various attempts have been made to improve the lead-acid battery over time, through modifications at the positive electrode, the negative electrode, or the electrolyte. At the positive electrode, the grid wires may be made of alloys of lead with other metals, such as calcium, antimony or tin. In addition, in order to minimize corrosion damage at the positive electrode, some lead-acid batteries use grids in the positive electrodes made with thicker grid wires. Certain solutions also increase the lifetime of the lead-acid battery by increasing the density of the positive material. In addition, an additive may be introduced at the interface between the active lead material and the grid wires on the positive electrode, in order to prevent self-discharge and growth of a lead-sulfate layer on the positive electrode, by catalysing the chemical reaction of the active material. At the negative electrode, additives may be added to the negative material paste, such as a nanocarbon, activated carbon, antimony, or a barium sulfate salt containing strontium. Variations involving the electrolyte solution include, for example, changing the electrolyte from sulfuric acid to lithium sulfate, or adding polyvinyl alcohol or sorbic acid to the solution.

### SUMMARY OF THE INVENTION

Despite the various modifications for extending the lifetime of the lead acid battery, none of the proposed solutions fundamentally change the composition or method of operation of the lead acid battery. In particular, all existing models of lead acid batteries are chemically based on reactions with lead at both the positive and negative electrodes, and undergo Reactions (1) and (2) during the charging and discharging processes, respectively. In addition, none of the proposed solutions effectively reduce the weight of the lead acid battery, or prevent evaporation of the electrolyte over a long series of charges.

The present disclosure presents a fundamentally new model for a lead acid battery in which the negative electrode, rather than consisting of a lead based grid and an active mass of lead, consists of a base material on which an active metal is deposited during the charging process. In the process of discharge, the active metal is dissolved in the electrolyte. The base material is a material with electrical conductivity and high electrochemical corrosion resistance, and may be present in a very thin layer, for example, from 0.1 mm and up to 10 mm. The active metal may be any suitable metal for undergoing redox reactions during charging and discharging. The disclosed battery has a service life of at least 5,000 charge-discharge cycles, and weighs between 40-60% of the weight of a traditional lead acid battery with the same energy capacity.

According to a first aspect, a lead acid battery includes a positive electrode comprised of a grid filled with an active mass of lead salts. A negative electrode is comprised of a base material. A spacer maintains a distance between the positive and negative electrodes. The battery further includes an active metal and an electrolyte solution. In a process of discharge, the active metal is dissolved in the electrolyte solution, and in a process of charge, the active metal is deposited onto the base material.

In another implementation according to the first aspect, the base material is one of graphite, titanium, gold, silver, copper, or lead.

In another implementation according to the first aspect, the base material is a combined base comprised of an inner base material coated with a coating metal. Optionally, the inner base material is copper and the coating metal is titanium, tungsten, niobium, tantalum, or lead; or the inner base material is graphite, and the coating metal is copper.

In another implementation according to the first aspect, the active metal is one of copper, tin, nickel, indium, cadmium, zinc, manganese, or iron.

In another implementation according to the first aspect, the base material is copper, and the active metal is tin.

In another implementation according to the first aspect, the base material is lead or copper coated with lead, and the active metal is nickel.

In another implementation according to the first aspect, the electrode of the base material has holes extending therethrough.

In another implementation according to the first aspect, the electrolyte solution comprises sulfuric acid. Optionally, when the battery is fully discharged, the electrolyte solution is an aqueous solution of a sulfate of the active metal, and when the battery is fully charged, the electrolyte is an aqueous solution of sulfuric acid. Optionally, a summarized discharging reaction of the lead acid battery at the positive and negative electrodes is

$${PbO}_{2} + Me + 2 {H}_{2} {SO}_{4} = {Me SO}_{4} + {PbSO}_{4} + 2 {H}_{2} O$$

and a charging reaction of the lead acid battery at the positive and negative electrodes is

$${Me SO}_{4} + {PbSO}_{4} + 2 {H}_{2} O = {PbO}_{2} + Me + 2 {H}_{2} {SO}_{4} ,$$

wherein Me is the active metal.

In another implementation according to the first aspect, the electrolyte solution comprises a hydrosulfate of a buffer cation comprising sodium, ammonium, magnesium, or aluminum. Optionally, when the battery is fully discharged, the electrolyte solution is an aqueous solution of a sulfate of the buffer cation and a sulfate of the active metal, and when the battery is fully charged, the electrolyte solution is an aqueous solution of a hydrosulfate of the buffer cation. Optionally, a discharging reaction of the lead acid battery is

$${PbO}_{2} + Me + 4 {Kt HSO}_{4} = {Me SO}_{4} + {PbSO}_{4} + 2 {H}_{2} O + 2 {Kt}_{2} {SO}_{4}$$

and a charging reaction of the lead acid battery is

$${Me SO}_{4} + {PbSO}_{4} + 2 {H}_{2} O + 2 {Kt}_{2} {SO}_{4} = {PbO}_{2} + Me + 4 {Kt HSO}_{4} ,$$

wherein Me is the active metal and Kt is the buffer cation.

In another implementation according to the first aspect, the grid is one of: a lead-based grid coated with a protective layer of tungsten, titanium, gold, niobium, palladium, platinum, or tantalum; or a grid completely made of tungsten, titanium, gold, niobium, palladium, platinum, or tantalum.

In another implementation according to the first aspect, the positive electrode is covered by a membrane.

In another implementation according to the first aspect, the spacer is made of a non-conductive polymer resistant to electrolyte. Optionally, the spacer is shaped as a frame including grooves in an upper part of the frame for passage therethrough of liquids and gases. Optionally, a mesh net is attached to the frame at a side of the positive electrode. Further optionally, the mesh net is formed of the same non-conductive polymer as the frame. Optionally, the frame includes chamfers in a region surrounding a base of the negative electrode.

In another implementation according to the first aspect, a layer of silicone oil with a density less than a density of the electrolyte solution is configured above a surface of the electrolyte solution.

According to a second aspect, a method of operating a lead-acid battery is disclosed. The lead acid battery comprises a positive electrode comprised of a lead-based grid filled with an active mass of lead salts, a negative electrode comprised of a base material, a spacer maintaining a distance between the positive and negative electrodes, and an electrolyte solution. The method includes: during a discharge of the lead acid battery, dissolving the active metal in the electrolyte solution, and during a charge of the lead acid battery, depositing the active metal onto the base material.

In another implementation according to the second aspect, the method further comprises, during a complete discharge of the lead acid battery, completely dissolving the active metal in the electrolyte solution, and, during a complete charge of the lead acid battery, completely depositing the active metal onto the base material.

### BRIEF DESCRIPTION OF THE DRAWINGS

In the drawings:

FIG. 1 is a schematic drawing illustrating a cross-section view of a first embodiment of a lead acid battery, according to embodiments of the present disclosure;

FIG. 2A is a cross section view of the spacer of the lead acid battery of FIG. 1, according to embodiments of the present disclosure;

FIG. 2B is a side view of the spacer of the lead acid battery of FIG. 1, according to embodiments of the present disclosure;

FIG. 2C is a top view of the spacer of the lead acid battery of FIG. 1, according to embodiments of the present disclosure;

FIG. 3 is a schematic drawing illustrating a bottom view of a frame for a lead acid battery, according to embodiments of the present disclosure;

FIG. 4 is a cross section view of the frame of FIG. 3, according to embodiments of the present disclosure; and

FIG. 5 is a side view of the frame of FIG. 3, according to embodiments of the present disclosure.

### DETAILED DESCRIPTION OF THE INVENTION

The present disclosure, in some embodiments, concerns a lead acid battery, and more specifically, but not exclusively, to a lead acid battery including a positive electrode comprised of a grid containing a lead-based active mass, a negative electrode comprised of a base material, and an active metal that is deposited onto the base during a charging process and is dissolved into the electrolyte during a discharging process.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

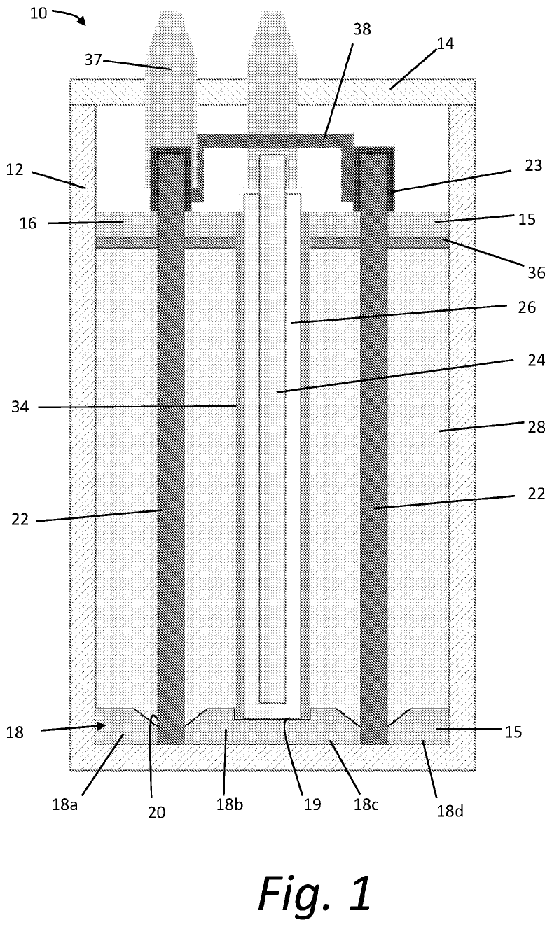

FIG. 1 illustrates a lead acid battery 10, according to embodiments of the present disclosure. The lead acid battery 10 is enclosed in a cell body 12 having cover 14. Cell body 12 and cover 14 are made of conventional materials.

Lead acid battery 10 includes, in the illustrated embodiment, two negative electrodes 22. The negative electrodes 22 are identical in all relevant respects, and thus, for the remainder of this disclosure, the negative electrodes 22 will be described in the singular. Negative electrode 22 is comprised of a base material. The base material has high electrical conductivity and high electrochemical corrosion resistance.

In some embodiments, the base material is a single material. The single material may be, for example, graphite, titanium, gold, silver, or copper.

In other embodiments, the negative electrode 22 is made of a combined base, comprised of an inner base material and a coating metal 23. The coating metal 23 may coat only the upper portion of the negative electrode 22, above the level of the electrolyte solution, as in the view of FIG. 1. Alternatively, the coating metal 23 may substantially encase the entire negative electrode 22. Exemplary combinations of base material and coating metals may include: the base material is copper, and the coating metal is titanium, tungsten, niobium, tantalum, or lead; or, the inner base material is graphite, and the coating metal is copper.

In exemplary embodiments, the minimum thickness of the negative electrode is at least 0.1 mm. Typically, a thickness of 1 mm is sufficient to achieve maximum performance of the negative electrode 22, although the negative electrode may have a thickness of up to 10 mm. When there is a coating metal, the thickness of the coating metal may be between 1 and 100 microns. Optionally, the negative electrode 22 of the base material has holes or cutouts passing through an entire thickness thereof. The holes or cutouts increase the surface of the negative electrode 22, which is especially useful for thicker negative electrodes 22.

Lead acid battery 10 further includes positive electrode 24. In a typical example, the positive electrode 24 is a plate electrode, and the term “positive plate” is used interchangeably for “positive electrode.” The positive plate 24 includes a grid. The grid may be based of lead, and may optionally include alloys of other materials such as tin, antimony or calcium. The lead-based grid is filled with a lead-based active mass. This active mass may consist of lead dioxide, when the battery is charged, and lead sulfate, when the battery is discharged. The shape of the grid, as well as the composition of the active material of the positive grid, are similar to those known to those of skill in the art, and may include, but are not limited to, plate electrodes, tube electrodes or cylindrical electrodes.

The positive electrode 24 may be covered by a membrane 26. The shape of the membrane, as well as its composition, are similar to those used in traditional lead acid batteries, as known to those of skill in the art.

The lead of the grid is preferably coated with a protective layer of tungsten, titanium, gold, niobium, palladium, platinum, or tantalum. The protective layer may have a thickness of 0.1 to 10.0 microns. The protective layer prevents local self-discharge of the positive electrode and also prevents destruction of the grid at the end of the charging process. Alternatively, instead of being made of lead, covered with one of the aforementioned metals, the grid may be made of tungsten, titanium, gold, niobium, palladium, platinum, or tantalum entirely. Of the aforementioned metals, tungsten and titanium are comparatively more widely available and less expensive.

Lead acid battery 10 further includes an aqueous electrolyte solution 28 and an active metal. When the battery 10 is in a discharged state, the electrolyte solution includes ions of an active metal. When the battery is in a charged state, the active metal is deposited onto the negative electrode 22.

The active metal may be, for example, one of copper, tin, nickel, cadmium, indium, zinc, manganese or iron. Certain active metals have been found to work effectively with certain base materials. For example, when the base material is copper, the active metal may preferably be tin. When the base material is lead or copper coated with lead, the active metal may preferably be nickel.

The electrolyte solution 28 may comprise sulfuric acid or a hydrosulfate of a buffer cation.

For an electrolyte solution comprising sulfuric acid, when the battery is fully discharged, the electrolyte is a saturated aqueous solution of a sulfate of the active metal. For example, the solution may include copper sulfate, tin sulfate, nickel sulfate, indium sulfate, cadmium sulfate, zinc sulfate, manganese sulfate or iron sulfate. When the battery is fully discharged, the electrolyte is an aqueous solution of sulfuric acid. The sulfuric acid is produced in-situ by the charging reaction in an approximate amount of 3.6-3.8 grams of acid per 1 ampere*hour of the capacity.

For the electrolyte solution comprising sulfuric acid, the summarized reaction during discharge is:

$${PbO}_{2} + Me + 2 {H}_{2} {SO}_{4} = {Me SO}_{4} + {PbSO}_{4} + 2 {H}_{2} O \qquad ( Equation 3 )$$

“Me” refers to the active metal. The lead dioxide at the positive electrode is converted into lead sulfate at the positive electrode; the metal at the negative electrode is converted to aqueous metal sulfate; and water is released into the aqueous solution. The summarized reaction during charge is the reverse:

$${Me SO}_{4} + {PbSO}_{4} + 2 {H}_{2} O = {PbO}_{2} + Me + 2 {H}_{2} {SO}_{4} \qquad ( Equation 4 )$$

In the case of an electrolyte comprising a hydrosulfate of a buffer cation, in a fully charged battery, the electrolyte may be an aqueous solution of a buffer cation hydrosulfate. For example, the solution may be aqueous ammonium hydrosulfate, sodium hydrosulfate, magnesium hydrosulfate, or aluminum hydrosulfate. The charging reaction provides 7.2-7.4 g of hydrosulfate ion (HSO₄⁻) per one ampere*hour of capacity. In the fully discharged state, the electrolyte is an aqueous solution of ammonium sulfate, sodium sulfate, magnesium sulfate, or aluminum sulfate. For these cations, the discharge reaction provides 3.6-3.7 g of sulfate ion (SO₄²⁻) per 1 ampere*hour of the capacity. In addition, the discharge reaction causes formation of an active metal sulfate (copper sulfate, tin sulfate, nickel sulfate, indium sulfate, cadmium sulfate, zinc sulfate, manganese sulfate or iron sulfate) in an amount providing 1.8-1.85 g of sulfate ion (SO₄²⁻) per 1 ampere*hour of the capacity.

For the electrolyte solution comprising a hydrosulfate of the buffer cation, the summarized reaction during discharge is:

$${PbO}_{2} + Me + 4 {Kt HSO}_{4} = {Me SO}_{4} + {PbSO}_{4} + 2 {Kt}_{2} {SO}_{4} \qquad ( Equation 5 )$$

“Me” refers to the active metal, and Kt refers to the buffer cation (sodium, ammonium, magnesium, or aluminum). The lead dioxide at the positive electrode is converted into lead sulfate at the positive electrode; the metal at the negative electrode is converted to aqueous metal sulfate; and two molecules of buffer cation sulfate are produced in the solution. The summarized reaction during charge is the reverse:

$${Me SO}_{4} + {PbSO}_{4} + 2 {Kt}_{2} {SO}_{4} = {PbO}_{2} + Me + 4 {Kt HSO}_{4} \qquad ( Equation 6 )$$

One advantage of using an electrolyte comprising a hydrosulfate of the buffer cation is that the electrolyte comprising a hydrosulfate of the buffer cation reduces the rate of a spontaneous or uncontrolled reaction at the negative electrode. This, in turn, reduces the self-discharge of the cell.

The lead acid battery 10 further includes a spacer 15. Unlike traditional lead acid batteries, in which electrodes are packed densely, in the lead acid battery according to the present disclosure, the electrodes must be placed at some distance from each other. In addition, it is necessary to ensure that there are equal distances between the positive electrode 24 and the negative electrode 22, in order to prevent uneven deposition of the active metal on the base portion of the negative electrodes 22.

In the embodiment of FIG. 1, the spacer 15 is a frame arranged within the body 12, made of non-conductive polymer resistant to electrolyte. Examples of such a polymer include polyethylene, polypropylene, polytetrafluoroethylene (Teflon®), phenol formaldehyde, or any compositions of the above-listed polymers with fiberglass. The height and width of the frame corresponds approximately to the height and width of membrane 26. The size of the frame defines the distance between the negative electrodes 22 and positive electrode 24. This distance, in turn, is determined by the amount of electrolyte solution required for the cell to operate. In exemplary embodiments, the thickness of the frame is between 1 mm and 5 mm.

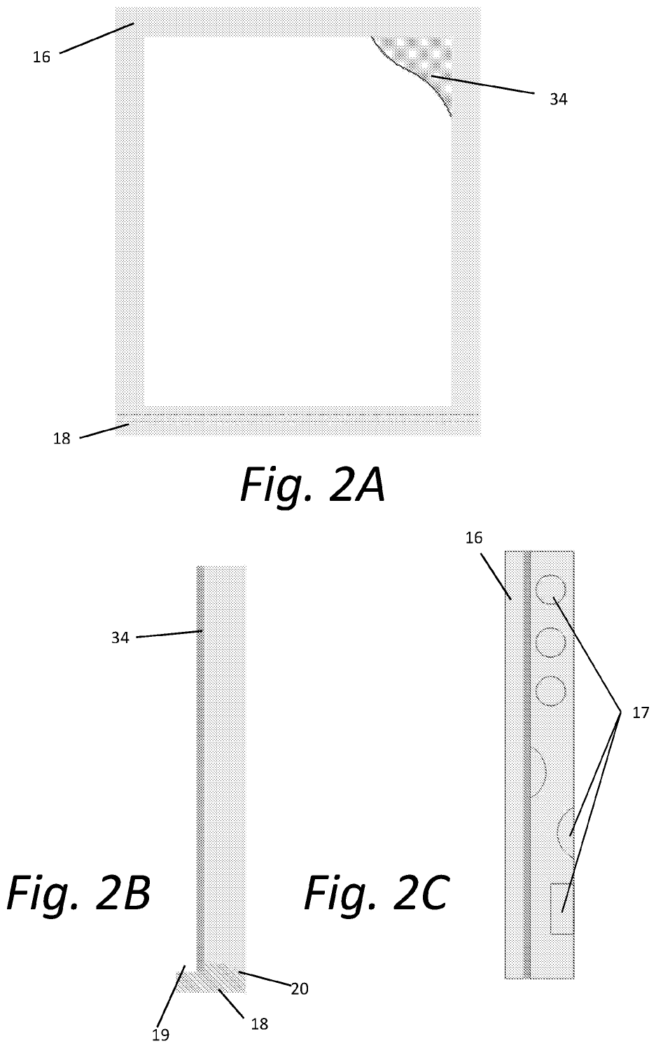

The frame includes a top portion 16, as shown in further detail in FIG. 2A and FIG. 2C, and a bottom portion 18, as shown in further detail at FIG. 2A and FIG. 2B. The bottom portion of the frame 18 may consist of multiple sections 18a, 18b, 18c, 18d. The multiple sections may permit the battery 10 to be assembled in a modular fashion. For example, section 18a may be inserted, followed by the negative electrode 22, followed by section 18b. Likewise, section 18d may be inserted, followed by the negative electrode 22, followed by section 18c. Sections 18b and 18c are then joined to form a protrusion 19 below the height of the rest of the bottom sections 18b, 18c, on which positive electrode 24 and the surrounding materials are placed. The height of protrusion 19 may be 3-5 mm. As part of the construction of the bottom portion 18, a chamfer 20 is formed around the negative electrode 22. The chamfer 20 may be between 1 and 5 mm high, with an angle of 15°-60°. The chamfer 20 is advantageous for at least two reasons. First, the chamfer 20 increases the open surface of the negative electrode 22, to increase the current of electrolyte solution 28 around the negative electrode 22. Second, and more significantly, it is possible that, during operation of the battery 10, small particles of the active metal will fall from negative electrode 22. The chamfer 20 causes these particles to concentrate at the lower part of the chamfer, close to the negative electrode 22, and thus eventually take place in the discharge reaction.

In the upper part of the frame, as seen in FIG. 2C, grooves or holes or cuts 17 are cut in the top portion 16. The grooves or holes or cuts permit passage of liquids and gases. In addition, to prevent deformation of the membrane 24, a mesh net 34 is attached to the frame, at the side of the membrane 24. The mesh net may be made of the same material as the spacer 15 itself.

To prevent natural evaporation of the electrolyte solution 28, silicone oil 36 is added into the composition of the battery cell. The silicone oil 36 has a density less than the density of the electrolyte solution. An exemplary thickness of the silicone oil layer is between 0.5-2 mm. The concern for evaporation of electrolyte solution 28 is especially relevant for the battery 10, which has a long lifetime and which does not lose its function due to factors such as self-discharge at the positive electrode. The silicone oil 36 effectively prevents loss of function due to evaporation even in longer-lasting batteries.

Battery 10 further includes current collectors 37 attached to the positive and negative electrodes 22, 24, and a bus connection 38 between the negative electrodes 22, in a manner known to those of skill in the art.

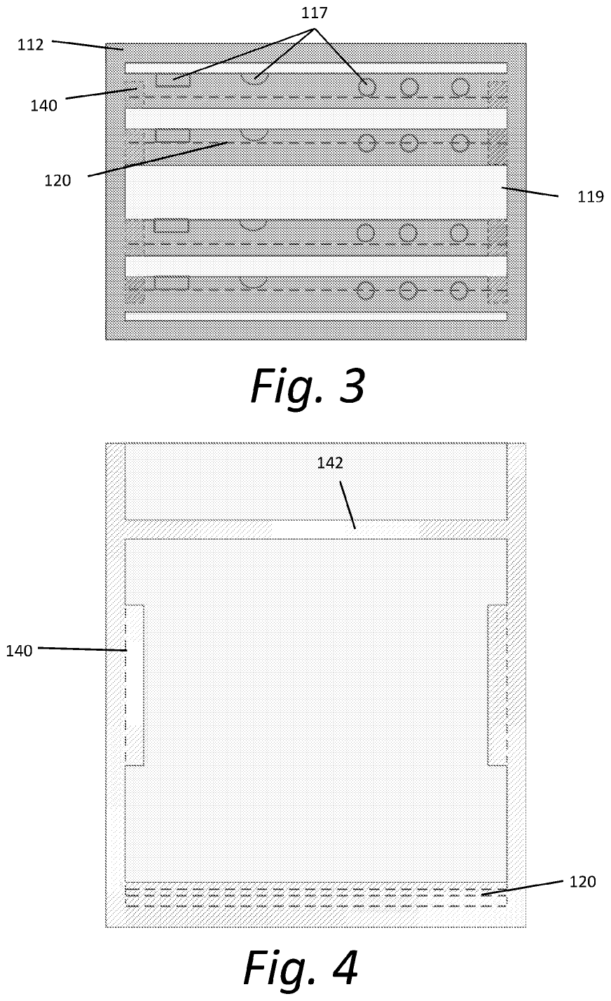

FIGS. 3-5 depict a second embodiment of body 112 of the battery. The operational components of the battery, such as the negative electrode, positive electrode, electrolyte solution, and active metal are the same as those described in connection with FIG. 1. The difference between body 112 and body 12 is that, instead of having a frame 15 inserted within the body, the body 112 contains cell body elements that perform the same functions.

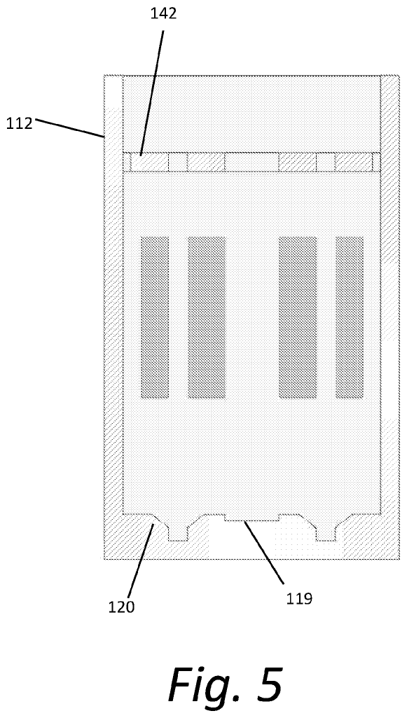

FIG. 3 depicts a bottom view of the body 112, FIG. 4 is a cross-section view of body 112, and FIG. 5 is a top view of body 112. Body 112 includes holes or cuts 117, protrusion 119, and chamfer 120 similar to those described in FIGS. 1 and 2A-2C. In addition, body 112 includes ribs 140 and rail elements 142, which guide and support the negative electrode within the body 112.

### EXAMPLES

Battery 10 was tested in the following examples, utilizing various different negative electrodes, active metals and various types of electrolyte solution.

Examples 1-7 all involve the use of an electrolyte comprising sulfuric acid and a graphite negative electrode, and differ only in the identity of the active metal. The examples are organized from lowest EMF generated (example 1) to the highest EMF generated (example 7).

### Example 1—Copper

A battery with electrolyte comprising sulfuric acid, copper as the active metal, and graphite as the negative electrode has the following summarized discharge reaction, based on equation 3:

$${PbO}_{2} + Cu + 2 {H}_{2} {SO}_{4} = {CuSO}_{4} + {PbSO}_{4} + 2 {H}_{2} O$$

The battery has the following charge reaction, based on equation 4:

$${CuSO}_{4} + {PbSO}_{4} + 2 {H}_{2} O = {PbO}_{2} + Cu + 2 {H}_{2} {SO}_{4}$$

The electromotive force (EMF) of the charged battery is 1.348 V. In the discharged battery, with a 1 ampere*hour capacity, the electrolyte is an aqueous solution comprised of 2.98 grams of CuSO₄, and the positive electrode has 9.82 grams of PbSO₄.

### Example 2—Tin

A battery with electrolyte comprising sulfuric acid, tin as the active metal, and graphite as the negative electrode has the following summarized discharge reaction, based on equation 3:

$${PbO}_{2} + Sn + 2 {H}_{2} {SO}_{4} = {SnSO}_{4} + {PbSO}_{4} + 2 {H}_{2} O$$

The battery has the following charge reaction, based on equation 4:

$${SnSO}_{4} + {PbSO}_{4} + 2 {H}_{2} O = {PbO}_{2} + Sn + 2 {H}_{2} {SO}_{4}$$

The electromotive force (EMF) of the charged battery is 1.82 V. In the discharged battery, with a 1 ampere*hour capacity, the electrolyte is an aqueous solution comprised of 4.01 grams of SnSO₄, and the positive electrode has 9.82 grams of PbSO₄.

### Example 3—Nickel

A battery with electrolyte comprising sulfuric acid, nickel as the active metal, and graphite as the negative electrode has the following summarized discharge reaction, based on equation 3:

$${PbO}_{2} + Ni + 2 {H}_{2} {SO}_{4} = {NiSO}_{4} + {PbSO}_{4} + 2 {H}_{2} O$$

The battery has the following charge reaction, based on equation 4:

$${NiSO}_{4} + {PbSO}_{4} + 2 {H}_{2} O = {PbO}_{2} + Ni + 2 {H}_{2} {SO}_{4}$$

The electromotive force (EMF) of the charged battery is 1.94 V. In the discharged battery, with a 1 ampere*hour capacity, the electrolyte is an aqueous solution comprised of 2.89 grams of NiSO₄, and the positive electrode has 9.82 grams of PbSO₄.

### Example 4—Indium

A battery with electrolyte comprising sulfuric acid, indium as the active metal, and graphite as the negative electrode has the following summarized discharge reaction, based on equation 3:

$$3 {PbO}_{2} + 2 In + 6 {H}_{2} {SO}_{4} = {{In}_{2} ( {SO}_{4} )}_{3} + 3 {PbSO}_{4} + 6 {H}_{2} O$$

The battery has the following charge reaction, based on equation 4:

$${{In}_{2} ( {SO}_{4} )}_{3} + 3 {PbSO}_{4} + 6 {H}_{2} O = 3 {PbO}_{2} + 2 In + 6 {H}_{2} {SO}_{4}$$

The electromotive force (EMF) of the charged battery is 2.03 V. In the discharged battery, with a 1 ampere*hour capacity, the electrolyte is an aqueous solution comprised of 3.22 grams of In₂(SO₄)₃, and the positive electrode has 9.82 grams of PbSO₄.

### Example 5—Cadmium

A battery with electrolyte comprising sulfuric acid, cadmium as the active metal, and graphite as the negative electrode has the following summarized discharge reaction, based on equation 3:

$${PbO}_{2} + Cd + 2 {H}_{2} {SO}_{4} = {CdSO}_{4} + {PbSO}_{4} + 2 {H}_{2} O$$

The battery has the following charge reaction, based on equation 4:

$${CdSO}_{4} + {PbSO}_{4} + 2 {H}_{2} O = {PbO}_{2} + Cd + 2 {H}_{2} {SO}_{4}$$

The electromotive force (EMF) of the charged battery is 2.09 V. In the discharged battery, with a 1 ampere*hour capacity, the electrolyte is an aqueous solution comprised of 3.89 grams of CdSO₄, and the positive electrode has 9.82 grams of PbSO₄.

### Example 6—Iron

A battery with electrolyte comprising sulfuric acid, iron as the active metal, and graphite as the negative electrode has the following summarized discharge reaction, based on equation 3:

$${PbO}_{2} + Fe + 2 {H}_{2} {SO}_{4} = {FeSO}_{4} + {PbSO}_{4} + 2 {H}_{2} O$$

The battery has the following charge reaction, based on equation 4:

$${FeSO}_{4} + {PbSO}_{4} + 2 {H}_{2} O = {PbO}_{2} + Fe + 2 {H}_{2} {SO}_{4}$$

The electromotive force (EMF) of the charged battery is 2.125 V. In the discharged battery, with a 1 ampere*hour capacity, the electrolyte is an aqueous solution comprised of 2.84 grams of FeSO₄, and the positive electrode has 9.82 grams of PbSO₄.

### Example 7-Zinc

A battery with electrolyte comprising sulfuric acid, zinc as the active metal, and graphite as the negative electrode has the following summarized discharge reaction, based on equation 3:

$${PbO}_{2} + Zn + 2 {H}_{2} {SO}_{4} = {ZnSO}_{4} + {PbSO}_{4} + 2 {H}_{2} O$$

The battery has the following charge reaction, based on equation 4:

$${ZnSO}_{4} + {PbSO}_{4} + 2 {H}_{2} O = {PbO}_{2} + Z n + 2 {H}_{2} {SO}_{4}$$

The electromotive force (EMF) of the charged battery is 2.45 V. In the discharged battery, with a 1 ampere*hour capacity, the electrolyte is an aqueous solution comprised of 3.01 grams of ZnSO₄, and the positive electrode has 9.82 grams of PbSO₄.

### Example 8—Manganese

A battery with electrolyte comprising sulfuric acid, manganese as the active metal, and graphite as the negative electrode has the following summarized discharge reaction, based on equation 3:

$${PbO}_{2} + M n + 2 {H}_{2} {SO}_{4} = {MnSO}_{4} + {PbSO}_{4} + 2 {H}_{2} O$$

The battery has the following charge reaction, based on equation 4:

$${MnSO}_{4} + {PbSO}_{4} + 2 {H}_{2} O = {PbO}_{2} + M n + 2 {H}_{2} {SO}_{4}$$

The electromotive force (EMF) of the charged battery is 2.864 V. In the discharged battery, with a 1 ampere*hour capacity, the electrolyte is an aqueous solution comprised of 2.82 grams of MnSO₄, and the positive electrode has 9.82 grams of PbSO₄.

Examples 9-12 all involve the use of an electrolyte comprising a hydrosulfate of the buffer cation, a graphite negative electrode, and zinc as the active metal, and differ only in the identity of the buffer cation.

### Example 9—Ammonium

A battery with electrolyte comprising a hydrosulfate of the buffer cation, zinc as the active metal, graphite as the negative electrode, and ammonium as the buffer cation, has the following summarized discharge reaction, based on equation 5:

$${PbO}_{2} + Z n + 4 N {H}_{4} {HSO}_{4} = {ZnSO}_{4} + {PbSO}_{4} + 2 {( N {H}_{4} )}_{2} {SO}_{4}$$

The battery has the following charge reaction, based on equation 6:

$${ZnSO}_{4} + {PbSO}_{4} + 2 {( N {H}_{4} )}_{2} {SO}_{4} = {PbO}_{2} + Z n + 4 N {H}_{4} {HSO}_{4}$$

The electromotive force (EMF) of the charged battery is 2.45 V. In the discharged battery, with a 1 ampere*hour capacity, the electrolyte is an aqueous solution comprised of 3.01 grams of ZnSO₄ and 4.93 grams of (NH₄)₂SO₄, and the positive electrode has 9.82 grams of PbSO₄.

### Example 10—Sodium

A battery with electrolyte comprising a hydrosulfate of the buffer cation, zinc as the active metal, graphite as the negative electrode, and sodium as the buffer cation, has the following summarized discharge reaction, based on equation 5:

$${PbO}_{2} + Z n + 4 {NaHSO}_{4} = {ZnSO}_{4} + {PbSO}_{4} + 2 N {a}_{2} {SO}_{4}$$

The battery has the following charge reaction, based on equation 6:

$${ZnSO}_{4} + {PbSO}_{4} + 2 N {a}_{2} {SO}_{4} = {PbO}_{2} + Z n + 4 {NaHSO}_{4}$$

The electromotive force (EMF) of the charged battery is 2.45 V. In the discharged battery, with a 1 ampere*hour capacity, the electrolyte is an aqueous solution comprised of 3.01 grams of ZnSO₄ and 5.3 grams of Na₂SO₄, and the positive electrode has 9.82 grams of PbSO₄.

### Example 11-Aluminum

A battery with electrolyte comprising a hydrosulfate of the buffer cation, zinc as the active metal, graphite as the negative electrode, and aluminum as the buffer cation, has the following summarized discharge reaction, based on equation 5:

$$3 {PbO}_{2} + 3 Z n + 4 A {l ( {HSO}_{4} )}_{3} = 3 {ZnSO}_{4} + 6 {H}_{2} O + 3 {PbSO}_{4} + 2 A {{l}_{2} ( {SO}_{4} )}_{3}$$

The battery has the following charge reaction, based on equation 6:

$$3 {ZnSO}_{4} + 6 {H}_{2} O + 3 {PbSO}_{4} + 2 A {{l}_{2} ( {SO}_{4} )}_{3} = 3 {PbO}_{2} + 3 Z n + 4 A {l ( {HSO}_{4} )}_{3}$$

The electromotive force (EMF) of the charged battery is 2.45 V. In the discharged battery, with a 1 ampere*hour capacity, the electrolyte is an aqueous solution comprised of 3.01 grams of ZnSO₄ and 4.26 grams of Al₂(SO₄)₃, and the positive electrode has 9.82 grams of PbSO₄.

### Example 12—Magnesium

A battery with electrolyte comprising a hydrosulfate of the buffer cation, zinc as the active metal, graphite as the negative electrode, and magnesium as the buffer cation, has the following summarized discharge reaction, based on equation 5:

$${PbO}_{2} + Z n + 2 M {g ( {HSO}_{4} )}_{2} = {ZnSO}_{4} + 2 {H}_{2} O + {PbSO}_{4} + 2 {MgSO}_{4}$$

The battery has the following charge reaction, based on equation 6:

$${ZnSO}_{4} + 2 {H}_{2} O + {PbSO}_{4} + 2 {MgSO}_{4} = {PbO}_{2} + Z n + 2 M {g ( {HSO}_{4} )}_{2}$$

The electromotive force (EMF) of the charged battery is 2.45 V. In the discharged battery, with a 1 ampere*hour capacity, the electrolyte is an aqueous solution comprised of 3.01 grams of ZnSO₄ and 4.47 grams of MgSO₄, and the positive electrode has 9.82 grams of PbSO₄.

Certain of the materials used in Examples 1 to 12 may be varied, according to the teachings described above. For example, in each of Examples 1-12, the graphite negative electrode maybe replaced by titanium; or gold; or silver; or graphite coated fully or partially by copper; or copper coated with a layer of titanium or tungsten or niobium or tantalum. An advantage of using graphite compared to the alternatives described herein is that graphite is less expensive.

In example 2, the graphite negative electrode may be replaced by copper.

In example 3, the graphite negative electrode may be replaced by lead or copper coated with lead.

In examples 9-12, the zinc as active metal maybe replaced by copper or tin or nickel or indium or cadmium or manganese or iron. If replaced, the electrolyte in the discharged battery with 1 ampere*hour capacity will comprise the appropriate sulfate as specified in examples 1-8. In addition, the electromotive force will be as specified in examples 1-8 for the corresponding active metal. If zinc is replaced by tin, the graphite negative electrode may be replaced by copper. If zinc is replaced by nickel, the graphite negative electrode maybe replaced by lead or copper coated with lead.

1.-24. (canceled)

25. A lead acid battery, the battery comprising:
a) a positive electrode comprised of a grid filled with a lead-based active mass;
b) a negative electrode comprised of a base material;
c) a spacer maintaining a distance between the positive and negative electrodes;
d) an active metal, said active metal not being lead; and
e) an electrolyte solution;
wherein, in a process of discharge, the active metal is dissolved in the electrolyte solution, and, in a process of charge, the active metal is deposited onto the base material.

26. The lead-acid battery of claim 25, wherein the base material is one of graphite, titanium, gold, silver, copper, or lead; or wherein the base material is a combined base comprised of an inner base material coated with a coating metal, wherein either (1) the inner base material is copper, and the coating metal is titanium, tungsten, niobium, tantalum, or lead; or (2) the inner base material is graphite, and the coating metal is copper.

27. The lead-acid battery of claim 25, wherein the negative electrode has holes extending therethrough.

28. The lead acid battery of claim 25, wherein the active metal is one of copper, tin, nickel, indium, cadmium, zinc, manganese or iron.

29. The lead acid battery of claim 25, wherein the electrolyte comprises sulfuric acid.

30. The lead acid battery of claim 29, wherein, when the battery is fully discharged, the electrolyte solution is an aqueous solution of a sulfate of the active metal, and when the battery is fully charged, the electrolyte solution is an aqueous solution of sulfuric acid, wherein a summarized discharging reaction of the lead acid battery at the positive and negative electrodes is
$${PbO}_{2} + M e + 2 {H}_{2} {SO}_{4} = {MeSO}_{4} + {PbSO}_{4} + 2 {H}_{2} O$$
and a summarized charging reaction of the lead acid battery at the positive and negative electrodes is
$${MeSO}_{4} + {PbSO}_{4} + 2 {H}_{2} O = {PbO}_{2} + M e + 2 {H}_{2} {SO}_{4} ,$$
wherein Me is the active metal.

31. The lead acid battery of claim 25, wherein the electrolyte solution comprises a hydrosulfate of a buffer cation comprising sodium, ammonium, magnesium, or aluminum.

32. The lead acid battery of claim 31, wherein, when the battery is fully discharged, the electrolyte solution is an aqueous solution including a sulfate of the buffer cation and a sulfate of the active metal, and when the battery is fully charged, the electrolyte solution is an aqueous solution of the hydrosulfate of the buffer cation wherein a discharging reaction of the lead acid battery is
$${PbO}_{2} + Me + 4 {Kt HSO}_{4} = {MeSO}_{4} + {PbSO}_{4} + 2 {H}_{2} O + 2 {Kt}_{2} {SO}_{4}$$
and a charging reaction of the lead acid battery is
$${MeSO}_{4} + {PbSO}_{4} + 2 {H}_{2} O + 2 {Kt}_{2} {SO}_{4} = {PbO}_{2} + M e + 4 {Kt HSO}_{4} ,$$
wherein Me is the active metal and Kt is the buffer cation.

33. The lead acid battery of claim 25, wherein the grid is one of: a lead-based grid coated with a protective layer of tungsten, titanium, gold, niobium, palladium, platinum or tantalum; or a grid completely made of tungsten, titanium, gold, niobium, palladium, platinum, or tantalum.

34. The lead acid battery according to claim 25, wherein the positive electrode is covered with a membrane.

35. The lead acid battery of claim 25, wherein the spacer is made of a non-conductive polymer resistant to electrolyte, possibly shaped as a frame with or without grooves in an upper part of the frame for passage therethrough of liquids and gases; and with or without chamfers in a region surrounding a base of the negative electrode.

36. The lead acid battery of claim 35, further comprising a mesh net attached to the spacer at a side of the positive electrode, wherein the mesh net is formed of a non-conductive polymer resistant to electrolyte.

37. The lead acid battery of claim 25, further comprising a layer of silicone oil with a density less than a density of the electrolyte solution and configured above a surface of the electrolyte solution.

38. A method of operating a lead acid battery, wherein the lead acid battery comprises a positive electrode comprised of a grid filled with a lead-based active mass, a negative electrode comprised of a base material, a spacer maintaining a distance between the positive and negative electrodes, an active metal, said active metal not being lead, and an electrolyte solution, and the method comprises:
during a discharge of the lead acid battery, dissolving the active metal in in the electrolyte solution, and, during a charge of the lead acid battery, depositing the active metal onto the base material.

39. The method of claim 38, further comprising, during a complete discharge of the lead acid battery, completely dissolving the active metal in the electrolyte solution, and, during a complete charge of the lead acid battery, completely depositing the active metal onto the base material.
